(19) United States
(12) Patent Application Publication
(10) Pub. No.: US 2025/0095662 A1
(43) Pub. Date: Mar. 20, 2025

(54) ROBUST SPREAD-SPECTRUM SPEECH WATERMARKING USING LINEAR PREDICTION AND DEEP SPECTRAL SHAPING

(71) Applicant: Pindrop Security, Inc., Atlanta, GA (US)

(72) Inventors: David Looney, Atlanta, GA (US); Nikolay Gaubitch, Atlanta, GA (US)

(73) Assignee: Pindrop Security, Inc., Atlanta, GA (US)

(21) Appl. No.: 18/883,681

(22) Filed: Sep. 12, 2024

Related U.S. Application Data
(60) Provisional application No. 63/538,472, filed on Sep. 14, 2023.

(51) Int. Cl. G10L 19/018; G10L 25/30

(52) U.S. Cl. CPC G10L 19/018; G10L 25/30

(57) ABSTRACT

Embodiments disclosed herein include software processes executed by a computer for encoding and decoding watermarks for a speech signal in a call signal communicated via telephony channels. An encoder uses Linear Predictive Coding (LPC) to analyzes the call signal's spectral envelope and embeds the watermark into the LPC log-spectrum of the speech signal of the call signal. The encoder may reduce the watermark's strength at a formant peak of the speech signal, balancing the watermark's robustness and detectability. A deep decoder includes a neural network architecture trained on watermarked and watermark-free speech signals having various types of degradation to extract a feature vector of a call signal and compute a watermark detection score for one or more frames or for the call signal. At inference time, the deep decoder detects the watermark when the watermark detection score satisfies a detection threshold.

### CROSS-REFERENCE TO RELATED APPLICATIONS

This application claims the benefit of U.S. Provisional Application No. 63/538,472, filed Sep. 14, 2023, which is incorporated by reference in its entirety.

### TECHNICAL FIELD

This application generally relates to watermarking audio signals, including techniques for encoding audio signals by embedding watermarks with speech signals of the audio signals, and techniques for decoding audio signals having embedded watermarks with speech signals using deep neural network architectures.

### BACKGROUND

With the rise of generative AI, it is becoming increasingly more difficult to validate the authenticity of audio and video. The emergence of deepfake attacks, particularly involving synthetic speech directed at enterprise call centers, motivates a need for detecting synthetic speech. A possible solution is to apply a digital watermark to synthetically generated media content that can then be used to make users aware that the media is indeed synthetically generated. However, synthetic speech is typically generated with high quality at high sampling rates and by the time it reaches a call center they inevitably undergo a series of degradations, such as down-sampling, compression, acoustic noise, and reverberation, particularly when replayed through a loudspeaker or in telephony-based audio signals. This creates a significant challenge to robust watermarking. It would be beneficial to employ a watermarking solution that can be applied to synthetic speech to encode or decode watermarks into speech audio signals without a loss in audio quality, while also accommodating challenging degradations.

Another problem in watermarking in telephony-based audio arises in the need to balance or tailor robust watermarking against detectability or imperceptibility by humans listening to an audio playback of speech signals. A popular approach to watermarking that balances robustness and imperceptibility is the spread-spectrum technique. To date, spread spectrum watermarking has primarily been applied to music signals. Prior approaches to watermarking, particularly as applied to music signal data, are less-than-ideal or insufficient for more-simplified speech audio signals, such as telephony-based speech. This is due to naturally occurring differences between speech signals and music signals. As such, prior approaches of watermarking speech audio signals using spread-spectrum techniques are insufficient.

### SUMMARY

Disclosed herein are systems and methods capable of addressing the above-described shortcomings and may also provide any number of additional or alternative benefits and advantages. Embodiments include systems and methods for implementing watermarking in audio signal data containing speech signals. These embodiments include improved encoding and decoding operations, both model-based and data-driven, to better serve the watermarking of speech data.

Embodiments may include computing system(s) and computer-implemented method(s) for embedding watermarks in audio signals. A computer having at least one processor may execute operations of obtaining a watermarked audio signal including a speech signal and a watermark signal embedded at the speech signal; determining, by the computer, a strength of the watermark signal at a formant peak of the speech signal in the watermarked audio signal; determining, by the computer, a watermark strength reduction weighting based upon an amount of power of the speech signal at the formant peak; updating, by the computer, the strength of the watermark signal of the speech signal having the formant peak according to the watermark strength reduction weighting; and generating, by the computer, a revised watermarked audio signal including the watermark signal having the strength as updated using the watermark strength reduction weighting embedded at the speech signal.

The computer may generate the revised watermarked audio signal by embedding the revised watermarked audio signal in a transform domain of the watermarked audio signal at the formant peak of the speech signal.

When obtaining the watermarked audio signal, the computer may parse the watermarked audio signal into a plurality of frames. Each frame has a preconfigured frame-length for speech. The watermark signal has the frame-length, embedded by the computer, at the frame of the speech signal containing the formant peak.

When obtaining the watermarked audio signal, the computer may execute a transform function to generate a transformed representation of a watermark-free audio signal in a transform domain. The computer may generate the watermarked audio signal including the watermark signal by embedding the watermark signal in the transform domain of the speech signal of the watermark-free audio signal.

When obtaining the watermarked audio signal, the computer may generate a watermark sequence of the watermark signal including one or more watermark values in the transform domain.

When obtaining the watermarked audio signal, the computer may receive the watermarked audio signal via one or more networks.

When determining the strength of the watermark signal at the formant peak, the computer may identify the formant peak in the watermarked audio signal. The formant peak of the speech signal of the watermarked audio signal containing a relatively higher amount of power satisfying a peak-detection threshold and indicative of the formant peak at a portion of the speech signal of the watermarked audio signal. The computer may execute a Linear Predictive Coding (LPC) analysis for identifying the formant peak in a transform domain of the watermarked audio signal of the speech signal.

The computer may determine the watermark strength reduction weighting based upon a preconfigured penalty parameter and the amount of power of the speech signal at the formant peak.

The computer may execute a transform function on the revised watermarked audio signal in a transform domain to generate an audible representation of the revised watermarked audio signal in a time domain.

Embodiments may include computing system(s) and computer-implemented method(s) for watermark-decoding using machine-learning operations. A computer having at least one processor may execute operations of receiving an inbound call signal for an inbound call that originated via a telephony channel. The computer may generate a transformed representation of the inbound call signal indicating an amount of power at one or more frames in a transform domain at a portion of the inbound call signal. For each frame, the computer may extract a feature vector of a corresponding frame of the inbound call signal in the transform domain. The computer may generate, using a neural network architecture of a deep decoder, one or more watermark detection scores for the one or more frames of the inbound call signal using the feature vector of the corresponding frame. The neural network architecture is trained on a plurality of training call signals, including at least one training watermarked call signal and at least one training watermark-free call signal. The computer may identify a watermark signal being embedded in at least one frame of the inbound call signal in response determining that at least one watermark detection score satisfies a watermark detection threshold. The computer may generate a routing instruction indicating a call destination for the inbound call based upon the at least one watermark detection score.

The computer may train the neural network architecture of the deep decoder for generating a watermark detection score based upon the amount of power at the portion of a transform domain of a call signal.

When training the neural network architecture of the deep decoder, the computer may extract, using the neural network architecture, a training feature vector for a training call signal in the transform domain. The computer may generate, using the neural network architecture, a predicted watermark detection score for the training call signal using the training feature vector. The computer may generate, using a loss function, a level of error indicating a loss between the predicted watermark detection score and an expected watermark label, indicated by a training label associated with the training call signal.

Wherein training the neural network architecture of the deep decoder includes, the computer may, for each training call signal, generate, using a data augmentation operation, a training synthetic signal having a type of degradation in the transform domain according to the data augmentation operation corresponding to the type of degradation. The neural network architecture is iteratively trained by the computer using the plurality of training call signals that includes the training synthetic signal.

When training the neural network architecture of the deep decoder, the computer may extract, using the neural network architecture, a training feature vector in the transform domain for the training synthetic signal. The computer may generate, using the neural network architecture, a predicted watermark detection score for the training synthetic signal using the training feature vector. The computer may generate, using a loss function, a level of error indicating a loss between the predicted watermark detection score and an expected watermark label, indicated by a training label associated with the training call signal.

For each training call signal, the computer may generate a plurality of training synthetic signals using a plurality of data augmentation operations corresponding to a plurality of types of degradation used for generating the plurality of training synthetic signals. The type of degradation includes at least one of: additive noise, reverberation, down-sampling, packet loss, codec compression, delay, or filtering.

When receiving the inbound call signal, the computer parsing the inbound call signal into the one or more frames, including the frame containing a speech signal.

The routing instruction that indicates the call destination for the inbound call may indicate a call destination device for a call routing device. The routing instruction that indicates the call destination for the inbound call may include a graphical user interface indicating whether the watermark signal has been detected by the computer.

The computer may detect synthetic speech in the inbound call signal. The computer generates the one or more watermark detection scores for the inbound call signal in response to identifying the synthetic speech in the inbound call signal.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 is a block diagram showing dataflow amongst components of a system for adding or embedding watermarks to audio signals, according to an embodiment.

FIG. 2 is a block diagram showing dataflow amongst components of a system for decoding or detecting watermarks embedded into audio signals, according to an embodiment.

FIG. 3 shows components of a system for receiving and analyzing call data received during contact events for encoding or decoding watermarks, according to an embodiment.

FIG. 4 shows operations of a process for encoding audio signals by embedding and adjusting watermark signals using LPC-weighting operations, according to an embodiment.

FIG. 5 shows operations of a process for implementing deep decoding for decoding watermarked audio signals using a deep neural network architecture, according to an embodiment.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Embodiments include systems and methods for implementing watermarking in audio signal data containing speech signals. These embodiments include improved encoding and decoding operations, both model-based and data-driven, to better serve the watermarking of speech data. Watermarking audio signals is generally defined by a trade-off between robustness of the watermark signal (e.g., capability to persist despite degradations to the audio signal) against perceptibly or imperceptibility (e.g., probability humans detect the watermark because the watermark signal impacts the audio signal). Prior approaches for audio watermarking that satisfy these trade-off requirements include spread-spectrum modulation, among others. Spread-spectrum watermarking is routinely and commonly implemented in the music and other entertainment industries for managing and controlling intellectual property rights in recordings. Due to the popularity and prevalence of spread-spectrum watermarking, certain details of spread-spectrum watermarking need not be repeated herein to provide an understanding of the embodiments described herein.

Conventional approaches to spread-spectrum watermarking are insufficient for speech signals, particularly in a telephony context. It is generally more difficult to achieve a balance between imperceptibility and robustness when adding a watermark to speech compared to music. For instance, because there is comparatively more limited spectral content in speech signals, it is comparatively easier to embed a watermark that is more perceptible to a human, which may disrupt or distort the listener's enjoyment or understanding of the speech signal, or which may tip-off a fraudster that the speech signal contains a clandestine watermark. Prior approaches to spread-spectrum watermarking do not account for the differences between speech audio signals and music audio signals.

For example, prior approaches to spread-spectrum watermarking for music often embed watermarks a transform domain (e.g., LPC spectral domain, spectral domain, frequency domain) at portions of the music audio signal having a comparatively highest amount of power or energy. As such, the prior approaches to spread-spectrum watermarking generally embed the watermark in the loudest parts of an music audio signal. However, speech utilizes a simpler carrier signal compared to music, rendering watermark signals as more challenging to hide in speech signals compared to music. As another example, prior approaches to spread-spectrum watermarking parse and operate on frames of music audio signals that are typically too large for speech audio signals. Generally, for speech to maintain perceptual quality, watermarks need to be embedded in shorter timeframes (frames having shorter frame lengths) as compared against longer frames that are possible for embedding watermarks into music audio signals.

Embodiments include computing functions of encoding operations for embedding watermarks into audio signals, using spread-spectrum watermarking operations that are tailored for speech audio signals. A computer executing an encoder may perform functions for encoding an audio signal, including functions for embedding a watermark at the speech signal occurring in portions of the audio signal (or across the entire audio signal). The encoder is configured to embed the watermark using size and strength or intensity of the watermark that is more appropriately balanced or tailored for speech to avoid degrading the quality of the speech audio signal.

Embodiments may include configuring or adapting the encoder to implement a comparatively shorter frame size when operating on speech audio signals. The encoder parses the speech audio signal and watermark into fixed-size frames of a given frame-length. When encoding speech audio signals, the computer may automatically or manually change (e.g., reduce) or cap the size of the frame-lengths.

Embodiments may implement LPC (Linear Predictive Coding) for analyzing the audio signals, among other operations. Generally, LPC is a technique or approach for estimating parameters of an audio signal, typically the coefficients of a linear filter that can predict the current sample of the signal based on past samples. An LPC analysis assumes that each sample of the audio signal (e.g., frames, signals) can be approximated as a linear combination of previous samples (e.g., previous frames, previous signals). A computer estimates the coefficients of this combination to minimize a prediction error of parameters or whether watermarks are present. In watermarking, the LPC analysis can be used to encode a feature vector of the watermark in the spectral domain or other transform domain representation of the audio signal, helping the watermark to remain robust against certain types of signal degradations.

The LPC analysis can be used to identify certain attributes of the audio signal when encoding and embedding the watermark, such as portions of the audio signal containing relatively and comparatively higher or lower amounts of power. A computer may, for example, generate or reference a LPC representation of the speech audio signal (in a log-spectrum domain) to identify, mitigate, or avoid watermark embeddings occurring at a prominent formant peak of the speech audio signal. In some embodiments, the computer may use the LPC analysis to identify, for example, quietest or weakest portions of the speech spectrum at formant troughs in which to embed the watermark into the speech audio signal, and/or the loudest or most powerful portions as in of the speech spectrum at the formant peaks in which to avoid embedding watermark or weaken an existing watermark.

In some embodiments, the computer adjusts or reduces the strength or intensity of the watermark using LPC-based watermark strength reduction weights (sometimes referred to as LPC-weightings). The computer determines the relative strength of the watermark at the identified formant peaks and then computes the LPC-weightings for the watermark signal at the given frame or portion of the audio signal at the formant peak. The computer applies the LPC-weighting to the watermark for certain frequencies or power levels, thereby reducing the intensity or strength of the watermark at the given frame. In this way, the watermark embedding is less pronounced in the formant peaks in the log-spectral domain or spectral domain, and thus less perceptible by a human in the time domain when listening to the speech audio signal. Moreover, there is now more room to change or degrade the speech audio signal before the watermark becomes perceptible.

For some watermarking techniques, such as spread-spectrum watermarking discussed herein, degradations in watermarked audio signals con cause problems for decoding the watermark. Typically, spread-spectrum watermarking includes decoding functions that include performing a dot product to a decoded spectrum or expected watermark signal spectrum, often in combination with a cepstral filter. For instance, a computer executing a decoder may generate a dot product by multiplying the spectrum representation or vector of the watermarked audio signal frame against corresponding frames of, for example, an expected watermark signal or expected watermark-free audio signal. This approach is generally considered an optimal decoding approach for more simplistic degradation scenarios, which may occur for music audio signals (e.g., added white noise or Gaussian noise). The decode operation outputs a value indicating a difference or distance for each frame, and may then sum together these values, representing the probability that a frame or audio signal contains a watermark signal. However, the degradations imposed on the speech audio signals in telephony use-cases (e.g., a customer-caller calling a call center) are often more complex or disruptive compared to music audio signals. For instance, the audio speech signal be the result of being passed from a loudspeaker (e.g., additive ambient noise, delay) as a waveform that is captured and converted into an electronic signal by a microphone (e.g., filtering), and a telephony channel itself adds degradations (e.g., down-sampling, packet-loss, codec compression). The increased degree of degradations may cause the dot product operations to compute inaccurate distances or other outputs. As such, typical approaches to decoding using conventional dot product may be inaccurate or ineffectual in detecting watermarks in frames or in an audio signal.

Embodiments may include systems and methods for implementing a deep-learning decoding strategy (“deep decoding” or “deep decoder”) for decoding watermarking. The deep decoding may tailor, train, or tune layers of a machine-learning architecture for spread spectrum decoding operations to both host signals (i.e., speech signals) and complex degradation environments. Embodiments may include computing hardware and software for training, hosting, and executing one or more neural network architectures for performing the functions and features of the deep decoding to predict and detect a watermark in a frame or aggregation of frames. In training, the computer and loss functions train or tune weights or parameters of the decode functions of the deep decoder to optimize on discriminating features of the audio signals (e.g., frequencies) that have greater impact or lesser impact on the prediction. Rather than summing the watermark detection value for each frame (as in conventional dot product), the deep decoder computes the watermark detection value based on the weights assigned to the frequencies in the frame.

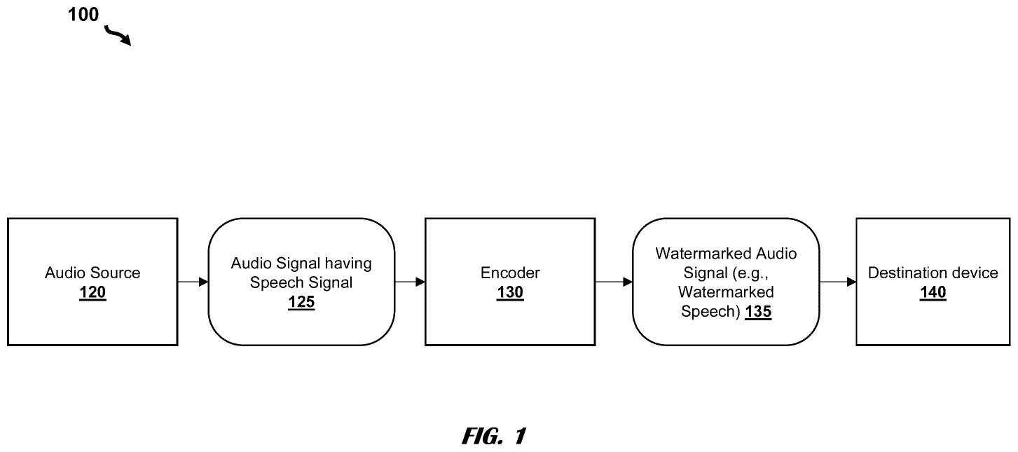

FIG. 1 is a block diagram showing dataflow amongst components of a system 100 for adding or embedding watermarks to audio signals 125. The system 100 includes audio sources 120 that transmit audio signals 125 to one or more computing devices executing an encoder 130. The encoder 130 ingests an audio signal 125, executes one or more operations for embedding a watermark signal into the audio signal 125, and generates or otherwise outputs a watermarked audio signal 135 corresponding to the audio signal 125.

The audio source 120 may include any electronic device capable of storing, generating, or transmitting an audio signal 125 to the encoder 130. The audio source 120 may include any electronic device hardware components (e.g., one or more processors, networked communications devices, telecommunications devices, non-transitory machine-readable storage media) and software components (e.g., encoder software, network communications protocols and software, telecommunications protocols and software) capable of performing various operations and tasks described herein. The audio source 120 may capture, store, transmit, or otherwise provide the audio signal 125 to the hardware or software components of the encoder 130.

The audio source 120 includes a computing device comprising a processor and non-transitory machine-readable storage media for storing audio signals 125 and transmitting each audio signal 125 to the encoder 130. As an example, the audio source 120 may include a call database, or any other type of database (e.g., analytics database 304, provider database 312, TTS database 324) accessible to the encoder 130, capable of storing recordings containing audio signals 125, such as telephony call signals received via one or more telephony channel or telephony call signals received via one or more data communications channels. In some embodiments, the audio source 120 includes an electronic computing device comprising, or coupled to, a microphone for capturing audio waveforms and converting the audio waveforms to one or more audio signals 125.

In some embodiments, the audio sources 120 may include an electronic computing device comprising hardware and software components, including one or more processors, for transmitting or otherwise providing the audio signal 125 to the encoder 130, such as a computing device of a text-to-speech (TTS) service (e.g., TTS server 322 of a TTS system 320). Non-limiting examples of an audio source 120 includes microphones, databases (e.g., TTS databases 324, analytics database 304, provider database 312), smartphones (e.g., mobile phone 314b), tablets, servers (e.g., analytics server 302, TTS server 322, provider server 311), and personal computers (e.g., computing device 314c), among others.

The encoder 130 may be executed or otherwise hosted on one or more computing devices (e.g., TTS servers 322, mobile phone 314b, computing device 314c) comprising hardware components (e.g., one or more networked processors, communications devices, telecommunications devices, non-transitory machine-readable storage media) and software components (e.g., encoder software, network communications protocols and software, telecommunications protocols and software) capable of performing various operations and tasks described herein. In some embodiments, the encoder 130 includes a computing device comprising a processor and non-transitory machine-readable storage media for embedding a watermark signal into the audio signal 125 and outputting the corresponding watermarked audio signal 135. The device executing or hosting the encoder 130 may include hardware and software components for receiving the audio signal 125 from the audio source 120 or transmitting the watermarked audio signal 135 to a destination device 140 (or returned to the audio source 120 as the destination device 140) via one or more networks. Non-limiting examples of the device hosting or executing the encoder 130 include smartphones, tablets, servers (e.g., TTS servers 322), and personal computers, among others.

As described in FIG. 1, the audio source 120, the encoder 130, and the destination device 140 are distinct devices, though embodiments are not so limited. As an example, the smartphone may include a microphone as the audio source 120 that captures and generates the audio signal 125 and feeds the audio signal 125 to the encoder 130. The example smartphone executes the encoder 130, taking the audio signal 125 as input, to generate the watermarked audio signal 135. The smartphone may transmit the watermarked audio signal 135 to a call center device as the destination device 140.

The encoder 130 executes spread-spectrum watermarking operations for generating the watermarked audio signal 135. The spread-spectrum watermarking operations include, for example, pre-processing operations and Linear Prediction Coding (LPC) analysis. The pre-processing operations include one or more transformation operations, such as Short-Time Fourier Transform, Discrete Fourier Transform (DFT), and Fast Fourier Transform (FFT), among others. The pre-processing operations may include parsing the audio signal 125 into one or more frames of a pre-configured to dynamically determine frame-length. Generally, the encoder 130 obtains and embeds a watermark (w) to a speech signal (s (n)) of the audio source 120. The encoder 130 may obtain (e.g., generate, extract, retrieve) the watermark a pseudo-random sequence of within a range of values (e.g., sequence value between 1 and −1), which the encoder 130 may generate or convert as a feature vector or other form of data structure.

The encoder 130 obtains the feature vector of the watermark sequence and embeds the feature vector of the watermark into a transform representation of the audio signal 125 in the transform domain (e.g., log-spectral domain, spectral domain, frequency domain). The encoder 130 obtains the audio signal 125 and executes a transform function on the audio signal 125 to generate the transform representation of the audio signal 125 in the transform domain. The encoder 130 applies or embeds the watermark sequence into the transform representation of the audio signal 125 in the given transform domain. As an example, the encoder 130 parses the audio signal 125 into a set of one or more frames, where each frame has standard or dynamically determined frame-length (L).

To embed the watermark to the audio signal 125, the encoder 130 executes the transform operation (e.g., STFT) to embed the watermark to the audio signal 125 at the I-th in the log-spectral domain using the watermark embedding function of Equation 1 (below):

$${X}_{dB} ( l ) = {S}_{dB} ( l ) + δ ω , \qquad ( Equation l )$$

where/represents an index in time, frequency, or another domain depending on the context of the signal processing (e.g., time index in a time series, frequency index in a spectrum); X_{dB}(l) represents the watermarked audio signal 135 in the transform power log-spectrum domain (e.g., decibel (dB) or log-spectrum spectrum power domain) at the time or frequency index; S_{dB}(l) represents the original audio signal 125 in the transform power log-spectrum domain (e.g., dB domain) at the same index; δ represents a scaling factor, gain, or strength of the watermark signal, where the scaling factor δ modulates the strength or impact of the watermark w within the overall watermarked audio signal 135 X_{db}; and where w represents the watermark pattern or sequence being embedded into the original audio signal 125 S_{dB}, which is the actual watermark w that is added to the original audio signal 125 S_{dB} to create the watermarked audio signal 135 X_{dB}.

Equation 1 describes how the watermarked audio signal 135 X_{db} (l) is generated by adding a scaled version of the watermark ow having a given strength to the audio signal 125 S_{dB}(l).

In some cases, the original audio signal S_{dB}(l) in the transform power domain (e.g., dB domain) at the I-th frame may be determined using Equation 2 (below):

$${S}_{dB} ( l ) = {20}_{log} 10 ( \vert S ( k , l ) \vert ) , \qquad ( Equation 2 )$$

where k is a frequency index in a transform domain (e.g., frequency domain, spectrum domain, log-spectrum domain); l is the time index in a time domain or other index in another domain; S(k,l) include a discrete Fourier transform (DFT) of the I-th frame of is the original audio signal 125 in a transform domain having k and/indices; and (|S(k,l)|) represents that the magnitude at indices k and/of the audio signal 125. Equation 2 is an example transform operation for converting a signal's magnitude to a transform power domain (e.g., decibel scale).

Using the absolute value of one or more feature vectors of the watermarked audio signal 135 in the transform domain, |X(k,l)|, and a phase of the initial signal 125 at the indices, S(k,l), the encoder 130 may reconstruct the now-watermarked audio signal 135 x(n) in the time domain and audible based on one or more transform functions.

The encoder 130 may be manually or automatically configured to parse the audio signal 125 or embed the watermark signal according to a particular frame-length (L) value. In some cases, for example, an administrative device or other graphical user interface may enter user inputs indicating configuration parameters that expressly indicate the frame-length (L). In some implementations, for example, the frame-length (L) is related to a watermark length (N_{w}) by N_{w}≤L/2+1, where a number of discrete DFT points are equivalent to the frame-length.

It is generally more difficult to achieve a balance between imperceptibility and robustness when adding the watermark to a speech signal in audio source 120 as compared to a music signal due to the more-limited spectral content of the speech signals. The selection of the frame-length (L) governs the length of the watermark signal, which in turn is related to robustness.

Generally, increasing the frame-length when generating the watermarks or parsing the speech signals, causes greater degradation in the speech signal quality. The music audio quality on the other hand is generally unaffected by the frame-length. As such, the encoder 130 may be configured to implement frame-lengths for the music audio signals (e.g., 20 ms to 200 ms) that are comparatively longer than the frame-lengths for the speech audio signals (e.g., 20 ms to 30 ms), providing a frame-length having an optimal trade-off between perceptibility and robustness. By contrast, for music signals on the other hand, the encoder 130 may implement a frame-length that is comparatively much longer for greater robustness with limited perceptual degradation.

The encoder 130 generates and outputs the watermarked audio signal 135, comprising the speech audio signal (of the audio signal 125) and the watermark signal embedded at portions of the audio signal 125 (or only at portions of the speech audio signal within the audio signal 125). In some embodiments, the device having the encoder 130 may transmit the watermarked audio signal 135 to the destination device 140. The encoder 130 may output the watermarked audio signal 135 in a spectral format in a transform domain (e.g., log-spectrum domain, spectrum domain, frequency domain) or in the time domain as an audio file or data stream containing audible playback data.

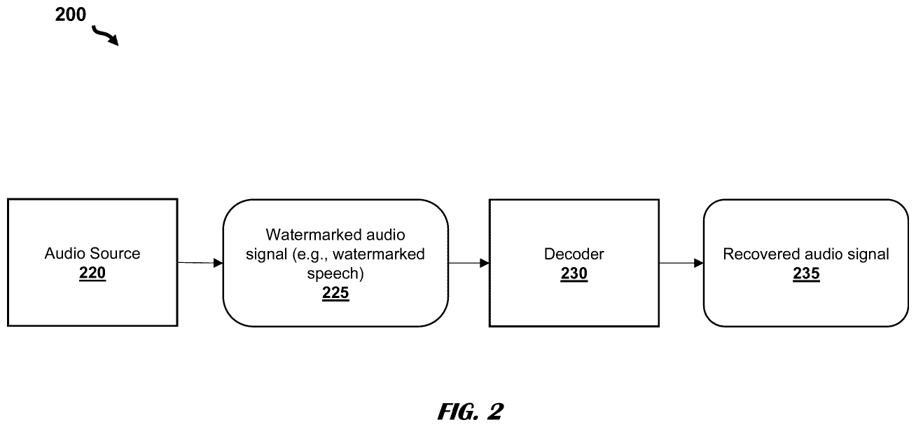

FIG. 2 is a block diagram showing dataflow amongst components of a system for decoding or detecting watermarks embedded into audio signals. The system 200 includes audio sources 220 that transmit watermarked audio signals 225 to one or more computing devices executing a decoder 230. The decoder 230 ingests a watermarked audio signal 225 from an audio source 220, executes one or more operations for decoding a watermark signal embedding in the watermarked audio signal 225. The decoder 230 may generate or output various types of data or metadata. For example, the decoder 230 may generate a recovered audio signal 235 as an audio signal without an embedded watermark signal. As another example, the decoder 230 may generate or output metadata about the watermarked audio signal 225, the recovered audio signal 235, or the audio source 220.

The audio source 220 may include any electronic device capable of. The audio source 220 may include any electronic device hardware components (e.g., one or more processors, networked communications devices, telecommunications devices, non-transitory machine-readable storage media) and software components (e.g., encoder software, network communications protocols and software, telecommunications protocols and software) capable of performing various operations and tasks described herein. The audio source 220 may, for example, capture, store, transmit, or otherwise provide the watermarked audio signal 225 to a decoder 230. In some embodiments, the audio source 220 includes a computing device comprising a processor and non-transitory machine-readable storage media for storing watermarked audio signals 225 and transmitting each watermarked audio signal 225 to the decoder 230. As an example, the audio source 220 may include a database (e.g., analytics database 304, provider database 312) for storing various types of call data, which may include any number of recordings or audio signal data containing initial audio signals (e.g., audio signals 125, recovered audio signals 235) or watermarked audio signals 225, and metadata associated with the stored audio signal data (e.g., training labels, metadata information about callers or calling devices). In some embodiments, the audio source 220 includes an electronic computing device comprising hardware and software components, including one or more processors, for transmitting or otherwise providing the watermarked audio signal 225 to the decoder 230. Non-limiting examples of an audio source 220 includes databases, smartphones (e.g., mobile phone 314b), tablets, servers (e.g., TTS servers 322), and personal computers, among others.

In some embodiments, the decoder 230 executes operations and processes according to approaches that correspond to LPC-encoding processes discussed above in FIG. 1. In such embodiments, the decoder 230 implements typically approaches to decoding the watermarked audio signals 225 such that the decoder 230 may detect instances of one or more watermarks in the watermarked audio signal 225 and/or generate the recovered audio signal 235. Embodiments of the decoder 230 may implement various additional or alternative mechanisms for detecting watermarks signals and/or generating the recovered audio signal 235 corresponding to the watermarked audio signal 225.

In some embodiments, for detection, the decoder 230 may implement a dot product function or other watermark comparator function for detecting the watermark in the watermarked audio signal 225. As an example, the decoder 230 may perform a dot product or a matched filter as follows, in Equation 3 (below):

$$C ( {X}_{dB} , ω ) = {X}_{dB} ⋆ ω = E [ {X}_{dB} ⋆ ω ] + N ( 0 , {σ}_{s} / √ {N}_{w} ) , \qquad ( Equation 3 )$$

where σₛ is the standard deviation of the signal as a measure of the spread or variability of the signal or noise around a mean, and No is a length of the watermark sequence; where E[X_{dB}*ω] is an expected value of the dot product between a feature vectors of the watermarked audio signal (X_{dB}) and the watermark sequence pattern (ω) extracted from a log-spectrum power domain (or other transform domain); N(0, σₛ√N_{w}) represents a noise term that follows a normal distribution with a mean of 0 and a standard deviation of σₛ/WWW. Notably, the expected value (E) is equal to the watermark strength (δ), when the watermark is present (E[X_{dB}*ω]=δ). Generally, Equation 3 is an example function of the decoder 230 operations for evaluating a correlation or comparison between the feature vector representations of the watermarked audio signal (X_{dB}) and the watermark sequence pattern (ω) in the transform domain. In this way, the decoder 230 executes Equation 3 or similar operations to generate a watermark detection score indicating the likelihood that the expected watermark sequence is present in the watermarked audio signal 225 by evaluating how closely the watermarked audio signal 225 matches the watermark pattern in the presence of degradations, such as noise or reverberation. If the watermark detection score, C(X_{dB}, ω), is higher than the noise level and satisfies a detection threshold, then the decoder 230 predicts and detects that the watermark is present in a set of one or more frames or the watermarked audio signal 225 as a whole.

In some embodiments, the decoder 230 executes software programming and routines of a deep decoding engine (“deep decoder”) for deep decoding operations. For deep decoding, the decoder 230 executes operations that define various layers or functions of one or more machine-learning architectures, such as neural network architectures (e.g., recurrent neural network (RNN), convolutional neural network (CNN), or multiple neural network architectures for a deep neural network (DNN). The various operations and machine-learning layers of the deep decoder are programmed and trained to predict or generate a probability or likelihood that the watermarked audio signal 225 (or any inputted audio signal data) contains a watermark signal, which the decoder 230 may generate and output as a watermark detection score or similar outputs. When the decoder 230 detects the watermarked signal of the watermarked audio signal 225, then the decoder 230 may further perform operations for converting the watermarked audio signal 225 from the transform domain to the time domain and output a recovered audio signal 235 corresponding to the watermarked audio signal 225.

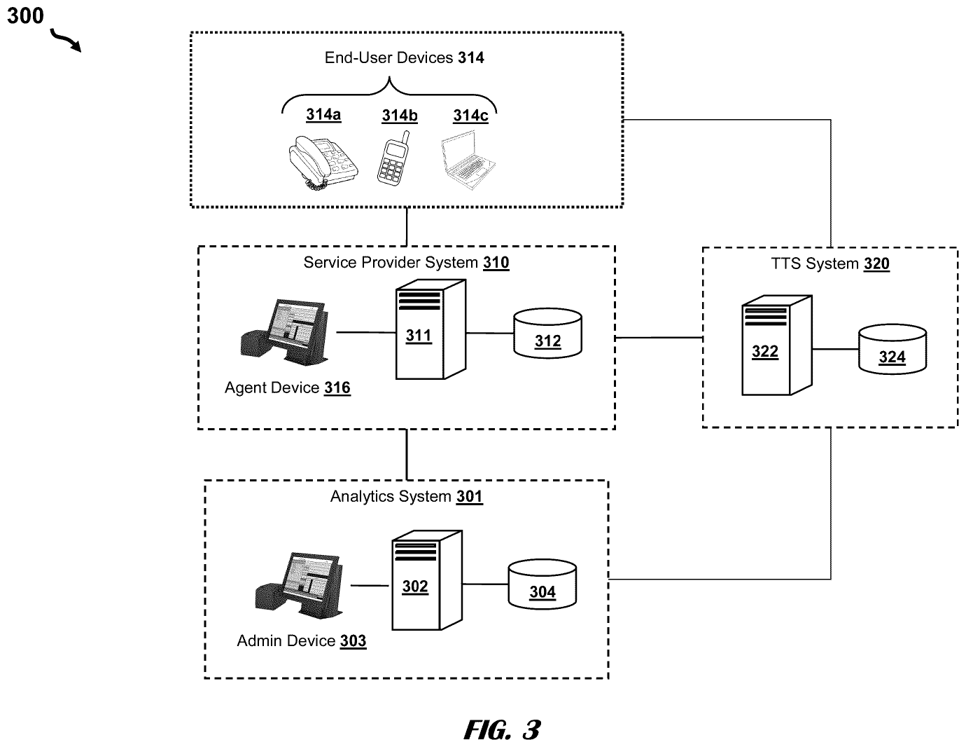

FIG. 3 shows components of a system 300 for receiving and analyzing call data received during contact events for encoding or decoding watermarks. The system 300 comprises an analytics system 301, service provider systems 310 of various types of enterprises (e.g., companies, government entities, universities), a text-to-speech (TTS) system 320, and one or more end-user devices 314a-314c, including landline phones 314a, mobile phones 314b, and computing devices 314c (generally referred to as the end-user devices 314 or the end-user device 314). The analytics system 301 includes analytics servers 302, analytics databases 304, and admin devices 303. The service provider system 310 includes provider servers 311, provider databases 312, and agent devices 316. The TTS system 320 includes TTS servers 322 and TTS databases 324.

Embodiments may comprise additional or alternative components or omit certain components from what is shown in FIG. 3, yet still fall within the scope of this disclosure. It may be common, for example, for the system 300 to include multiple provider systems 310 or multiple TTS systems 320, or for the analytics system 301 to have multiple analytics servers 302. It should also be appreciated that embodiments may include or otherwise implement any number of devices capable of performing the various features and tasks described herein. For example, the FIG. 3 shows the analytics server 302 as a distinct computing device from the analytics database 304, though in some embodiments, the analytics database 304 may be integrated into the analytics server 302.

Optionally, the system 300 may include an embodiment for call risk analysis, in which some embodiments include operations for caller identification, performed by the analytics system 301 on behalf of the provider system 310. The risk analysis operations are based on audio watermarks indicating the presence of synthetic speech and/or other characteristics of a projected audio wave or observed audio signal captured by a microphone of an end-user device 314. The analytics server 302 executes software programming of a machine-learning architecture having various types of functional engines, implementing certain machine-learning techniques and machine-learning models for analyzing the call audio data, which the analytics server 302 receives from the provider system 310. The analytics server 302 may execute various algorithms for detecting audio watermarks and extracting metadata of the audio watermarks to identify synthetic speech. The machine-learning architecture and/or algorithms of the analytics server 302 analyze the various forms of the call audio data to perform the various risk assessment or caller identification operations.

The TTS system 320 includes a TTS server 322 that executes software programming for generating synthetic speech signals as speech audio signals. The TTS server 322 or other device of the system 300 further executes software programming (e.g., encoder 130) for encoding an audio signal having a speech audio signal (e.g., synthetic speech, genuine speech audio), which includes embedding watermark signals into the speech audio signal generated by the TTS system 320 or other device of the system 300. In some implementations, the decoder further generates or captures metadata information regarding the watermarks and audio signals. The TTS server 322 or other device of the system 300 transmits or otherwise provides the call data, containing the audio signal data (e.g., watermarked audio signal) and the metadata information, to the analytics server 302, the provider server 311, or other type of destination device. In some cases, the end-user devices 314 generate the synthetic speech signals and encode watermarks in synthetic speech. In some cases, the analytics system 301 generates synthetic speech signals or encodes the watermarks in the synthetic speech for the TTS system 320.

The analytics system 301 includes an analytics server 302 that executes software programming (e.g., decoder 230) for decoding input audio signals and detecting the watermarks in the input audio signals in order to, for example, identify instances of fraudulent synthetic speech. When users access the TTS system 320 to generate the synthetic speech as speech audio signal and attempt to transmit or replay the synthetic speech at the service provider system 310, the call data is routed or forwarded from the service provider system 310 or the TTS system 320, to the analytics system 301, where the analytics server 302 is able to analyze and identify the synthetic speech on behalf of the service provider system 310.

The various components of the system 300 may be interconnected with each other through hardware and software components of one or more public or private networks. Non-limiting examples of such networks may include: Local Area Network (LAN), Wireless Local Area Network (WLAN), Metropolitan Area Network (MAN), Wide Area Network (WAN), and the Internet. The communication over the network may be performed in accordance with various communication protocols, such as Transmission Control Protocol and Internet Protocol (TCP/IP), User Datagram Protocol (UDP), and IEEE communication protocols. Likewise, the end-user devices 314 may communicate with callees (e.g., service provider systems 310) via telephony and telecommunications protocols, hardware, and software capable of hosting, transporting, and exchanging audio data associated with telephone calls. Non-limiting examples of telecommunications hardware may include switches and trunks, among other additional or alternative hardware used for hosting, routing, or managing telephone calls, circuits, and signaling. Non-limiting examples of software and protocols for telecommunications may include SS7, SIGTRAN, SCTP, ISDN, and DNIS among other additional or alternative software and protocols used for hosting, routing, or managing telephone calls, circuits, and signaling. Components for telecommunications may be organized into or managed by various different entities, such as, for example, carriers, exchanges, and networks, among others.

The analytics system 301, the provider system 310, and the TTS system 320 arc network system infrastructures 301, 310, 320 comprising physically and/or logically related collections of software and electronic devices managed or operated by various enterprise organizations. The devices of each network system infrastructure 301, 310, 320 are configured to provide the intended services of the particular enterprise organization.

The analytics system 301 is operated by a call analytics service that provides various call management, security, authentication (e.g., speaker verification), and analysis services to customer organizations (e.g., corporate call centers, government entities). Components of the call analytics system 301, such as the analytics server 302, execute various processes using audio data in order to provide various call analytics services to the organizations that are customers of the call analytics service. In operation, a caller uses a caller end-user device 314 to originate a telephone call to the service provider system 310. The microphone of the end-user device 314 observes the caller's speech and generates the audio data represented by the observed audio signal.

The end-user device 314 initiates and originates a call to the service provider system 310 and transmits the call data to the service provider system 310. The end-user device 314 and components of telephony networks and carrier systems (e.g., switches, trunks) or computing communications networks to perform telephony or networked-communications operations for handling and routing the call data of the new call, including, for example, interpretation, processing, transmission, and routing the call data from the end-user device 314 to the service provider system 310 or the TTS system 320. In some cases, the call data or audio signal data captured by a microphone of the end-user device 314 or generated by the TTS system 320, includes an audio watermark and metadata corresponding to an input speech audio (e.g., synthetic speech, human audio signal).

The service provider system 310 or the TTS system 320 then transmits the call data to the analytics system 301 to perform various analytics and downstream audio processing operations. It should be appreciated that analytics servers 302, analytics databases 304, and admin devices 303 may each include or be hosted on any number of computing devices comprising a processor and software and capable of performing various processes described herein.

The service provider system 310 is operated by an enterprise organization (e.g., corporation, government entity) that is a customer of the call analytics system 301. In operation, the service provider system 310 receives the audio data and/or the observed audio signal associated with the telephone call from the end-user device 314. The audio data may be received and forwarded by one or more devices of the service provider system 310 to the call analytics system 301 via one or more networks. For instance, the customer may be a bank that operates the service provider system 310 to handle calls from consumers regarding accounts and product offerings. Being a customer of the call analytics service, the bank's service provider system 310 (e.g., bank's call center) forwards the audio data associated with the inbound calls from consumers to the call analytics system 301, which in turn performs various processes using the audio data, such as analyzing the audio data to detect synthetic speech used to impersonate a customer of the bank, among other voice or audio processing services for risk assessment or speaker identification. It should be appreciated that service provider servers 311, provider databases 312 and agent devices 316 may each include or be hosted on any number of computing devices comprising a processor and software and capable of performing various processes described herein.

The end-user device 314 may be any communications or computing device the caller operates to place the telephone call to the call destination (e.g., the service provider system 310). The end-user device 314 may comprise, or be coupled to, a microphone. Non-limiting examples of end-user devices 314 may include landline phones 314a and mobile phones 314b. It should be appreciated that the end-user device 314 is not limited to telecommunications-oriented devices (e.g., telephones). As an example, a calling end-user device 314 may include an electronic device comprising a processor and/or software, such as a computing device 314c or Internet of Things (IoT) device, configured to implement voice-over-IP (VOIP) telecommunications. As another example, the caller computing device 314c may be an electronic IoT device (e.g., voice assistant device, “smart device”) comprising a processor and/or software capable of utilizing telecommunications features of a paired or otherwise networked device, such as a mobile phone 314b.

In the example embodiment of FIG. 3, when the caller places the telephone call to the service provider system 310, the end-user device 314 instructs components of a telecommunication carrier system or network to originate and connect the current telephone call to the service provider system 310. When the inbound telephone call is established between the end-user device 314 and the service provider system 310, a computing device of the service provider system 310, such as a provider server 311 or agent device 316 forwards the observed audio signal (and/or audio data sampled using components in the end-user device 314 from the observed audio signal) received at the microphone of end-user device 314 to the call analytics system 301 via one or more computing networks. The embodiment of FIG. 3 is merely a non-limiting example use for case of understanding and description.

The analytics server 302 of the call analytics system 301 may be any computing device comprising one or more processors and software, and capable of performing the various processes and tasks described herein. The analytics server 302 may host or be in communication with the analytics database 304 and may receive and process the audio data from the one or more service provider systems 310. Although FIG. 3 shows only a single analytics server 302, it should be appreciated that, in some embodiments, the analytics server 302 may include any number of computing devices. In some cases, the computing devices of the analytics server 302 may perform all or sub-parts of the processes and benefits of the analytics server 302. The analytics server 302 may comprise computing devices operating in a distributed or cloud computing configuration and/or in a virtual machine configuration. It should also be appreciated that, in some embodiments, functions of the analytics server 302 may be partly or entirely performed by the computing devices of the service provider system 310 (e.g., the service provider server 311).

In operation, the analytics server 302 may execute various software-based decode processes on the call data, which may include detection or identification of watermarks embedded in audio signals. The analytics server 302 may compute watermark detection scores for frames parsed from an input audio signal. The analytics server 302 identifies or detects the watermark in the frames or audio signal in response to determining that the watermark detection score satisfy a detection threshold. The analytics server 302 may determine, for example, the inbound audio signal contains synthetic speech from a TTS server 322 and includes a watermark associated with the TTS system 320, indicating to the analytics server 302 that the synthetic speech and the audio signal are each genuine or non-fraudulent uses of the TTS services of the TTS system 320 that generated the synthetic speech. As another example, the analytics server 302 may detect the synthetic speech of the inbound audio signal and does not identify or detect the expected watermark associated with the TTS system 320. In this example, the analytics server 302 determines that synthetic speech and inbound audio signal are potentially fraudulent, or at least not formally recognized, uses of the TTS services of the TTS system 320.

The analytics server 302 may return one or more fraud risk determinations to the provider server 311 of the service provider system 310, such as an indication that the analytics server 302 detected the watermark signal in the inbound audio signal and identified an inbound watermarked audio signal or an indication that the analytics server 302 did not detect the watermark signal and identified an inbound watermark-free audio signal.

In some embodiments, decoding operations may include deep decoding, which includes software programming for aspects of a machine-learning architecture executed by the analytics server 302 for detecting watermark signals, among other potential operations. The analytics server 302 may perform various pre-processing operations on the observed audio signal during training or deployment (sometimes referred to as “testing” or “inference time”) of machine-learning architectures. The pre-processing operations can advantageously improve the speed at which the analytics server 302 operates or reduce the demands on computing resources when analyzing the observed audio signal. The pre-processing operations may also advantageously provide data augmentation operations for training and developing a machine-learning architecture for robustness using synthetic training audio.

During pre-processing, the analytics server 302 parses the observed audio signal into audio frames having a frame-length containing portions of the audio data. Optionally, the analytics server 302 may scale the audio data in the audio frames. The analytics server 302 may further parse the audio frames into overlapping sub-frames. The frames may be portions or segments of the observed audio signal, where each frame has the fixed frame-length across the time series. The frame-length of the frames may be pre-established or dynamically determined by the analytics server 302 or other device executing the decoder (e.g., decoder 230). The sub-frames of a frame may have a fixed length that overlaps with adjacent sub-frames by some amount across the time series.

The analytics server 302 may execute one or more transform functions during pre-preprocessing. The transform function (e.g., DFT, STFT, FFT) transforms the audio data from a time-series time domain to a different representation, based on the transform function and transform domain. For instance, the analytics server 302 initially generates and represents the observed audio signal, audio frames, and sub-frames, according to a time domain. The analytics server 302 transforms the sub-frames (initially in the time domain) to a log-spectrum domain, frequency domain, or spectrogram representation, representing an amount of energy associated with the frequency components of the observed audio signal in each of the sub-frames, thereby generating a transformed representation. In some implementations, the analytics server 302 executes a FFT operation on the sub-frames to transform the audio data in the time domain to the frequency domain. For each frame (or sub-frame), the analytics server 302 performs a simple scaling operation so that the frame occupies the range [−1, 1] of measurable energy.

Pre-processing operations may include data augmentation operations for training one or more machine-learning architectures, such as layers of one or more neural network architectures or deep neural network (DNN) architecture, of a deep decoder engine (“deep decoder”). The analytics server 302 ingests training audio signals from a corpus database (e.g., provider database 312, analytics database 304, TTS databases 324) containing training audio signals. The analytics server 302 executes data augmentation operations on the training audio signals to impose or embed various types of degradation on the training audio signals. For a given training audio signal, the analytics server 302 executes one or more data augmentation operations for corresponding types of degradation. For the given training audio signal, the analytics server 302 feeds the training audio signal to the one or more data augmentation operation, each of which imposes a corresponding type of degradation on the input training audio signal and generates a synthetic training audio signal having the degradation. The data augmentation operations generate and output a set of synthetic training audio signals for the given input training audio signal, the analytics server 302 may store into the analytics database 304 or other database containing the corpus of training audio signals. The training audio signals are stored with training labels that indicate whether the particular training audio signal includes, for example, a watermark, genuine human speech, or synthetic speech. The analytics server 302 then trains the layers and machine-learning model the deep decoder using the training audio signals and training labels.

In some instances, the audio includes synthetic speech including a watermark, the synthetic speech generated by the TTS system 320. The analytics system 301 can apply expected watermark signal values, or keys used to generate the synthetic speech, to the audio to decode or detect the watermark and, in some embodiments, extract metadata from the watermark.

The TTS server 322 of the TTS system 320 may be any computing device comprising one or more processors and software, and capable of performing the various processes and tasks described herein. The TTS server 322 may host or be in communication with the TTS database 324 and may generate synthetic speech. The TTS server 322 may provide the synthetic speech to the user devices 314 and provide information regarding the synthetic speech (e.g., expected watermark signal values, watermark keys, metadata) to the analytics system 301. Although FIG. 3 shows only a single TTS server 322, it should be appreciated that, in some embodiments, the TTS server 322 may include any number of computing devices. In some cases, the computing devices of the TTS server 322 may perform all or sub-parts of the processes and benefits of the TTS server 322. The TTS server 322 may comprise computing devices operating in a distributed or cloud computing configuration and/or in a virtual machine configuration.

The TTS server 322 or other device of the system 300 may perform the various processes of an encoder (e.g., encoder 130) that embeds the watermark signal using the LPC-based spread-spectrum operations, embedding the watermark signal into speech signal of the audio signal. The result of the encoder executed by the TTS server 322 is that the watermark is embedded at the synthetic speech or human speech in the speech audio signal of the audio signal. The TTS server 322 may return the watermarked audio signal to the end-user device 314 or forward the watermarked audio signal to the service provider system 310. In some embodiments, the TTS server 322 may provide certain types of information regarding the TTS services or the synthetic speech (e.g., expected watermark signal values, watermark keys, metadata) to the analytics system 301 at an earlier time, which the analytics server 302 may store into and retrieve from the analytics database 304 during decode and detection operations.

Turning back to the analytics server 302, the analytics server 302 may transmit the detection indicators of the presence or absence of the watermark, and, in some implementations, the metadata extracted from the watermark back to the provider server 311 or to one or more downstream applications to perform various types of audio and voice processing operations. The downstream applications may be executed by the provider server 311, the analytics server 302, the admin device 303, the agent device 316, or any other computing device. Non-limiting examples of the downstream applications or operations may include speaker verification, speaker recognition, speech recognition, voice biometrics, audio signal correction, or degradation mitigation (e.g., dereverberation), and the like.

The provider server 311 of a service provider system 310 executes software processes for managing a call queue and/or routing calls made to the service provider system 310, which may include routing calls to the appropriate agent devices 316 based on the caller's comments, such as the agent of a call center of the service provider. The provider server 311 can capture, query, or generate various types of information about the call, the caller, and/or the end-user device 314 and forward the information to the agent device 316, where a graphical user interface on the agent device 316 is then displayed to the call center agent containing the various types of information. The provider server 311 also transmits the information about the inbound call to the call analytics system 301 to perform various analytics processes, including the observed audio signal and any other audio data. The provider server 311 may transmit the information and the audio data based upon a preconfigured triggering conditions (e.g., receiving the inbound phone call), instructions or queries received from another device of the system 300 (e.g., agent device 316, admin device 303, analytics server 302), or as part of a batch transmitted at a regular interval or predetermined time.

The provider server 311 executes a call center management and handling software (“call management engine”) for queuing, routing, and/or terminating the inbound calls received at the service provider system 310 from the end-user devices 314 or the TTS server 322. The call management software may route the inbound calls to an agent device 316 or external telephony systems. The call management engine routes the call according to a routing instruction as an input received from, for example, an Interactive Voice Response (IVR) software or server, agent device 316, or analytics server 302, or other computing device or software for generating the routing instruction.

As an example, the provider server 311 (or other device of the service provider system 310) may execute the call management engine and IVR software. The IVR software interacts with the caller to determine which call center agent can handle the caller's requests and identify which agent device 316 of the call center agent to route the inbound call. The IVR software may then generate a routing instruction for the call management engine to route the inbound call to the agent device 316, where the routing instruction includes machine-readable data indicating the agent device 316.

As another example, the analytics server 302 determines or detects that the inbound call signal of the inbound call includes synthetic speech in the speech audio signal. The analytics server 302 executes software operations of a decoder (or deep decoder) to determine whether the speech audio signal, having the synthetic speech, also includes a watermark, such as a validating expected watermark signal stored in a database (e.g., analytics database 304, provider database 312, TTS databases 324) authorized by or associated with a valid TTS system 320. In response to determining that speech signal of the inbound call signal includes a watermark signal, the analytics server 302 generates a machine-readable routing instruction for the provider server 311 (or other device executing the call management engine) indicating that the inbound call includes a validated watermark signal and instructs the call management engine to route the call to the call destination, such as the agent device 316 for handling the caller's service requests. In response to determining that speech signal of the inbound call signal includes a watermark signal, the analytics server 302 generates a machine-readable routing instruction for the provider server 311 (or other device executing the call management engine) indicating that the inbound call includes the synthetic speech without a validated watermark signal and instructs the call management engine to terminate the inbound call or route the call to a call destination for handling potentially fraudulent calls, such as the agent device 316 of an anti-fraud specialist or a third-party telephony system for handling potentially fraudulent calls.

In some embodiments, the routing instruction includes elements of a graphical user interface for display at an agent device 316 indicating information about the inbound call generated by analytics server 302. For instance, the analytics server 302 may determine one or more fraud risk scores and generate a graphical user interface output for the agent device 316 indicating the fraud risk scores and other information about the caller, end-user device 314, and/or other information about the inbound call. The graphical user interface may, for example, display and indicate whether the call center agent at the agent device 316 should continue to field or handle the inbound call, terminate the call, or route the call to another agent device 316. The analytics server 302 may generate the routing instruction for display at the agent device 316 indicating whether the analytics server 302 detected the synthetic speech in the inbound call audio signal and/or whether the analytics server 302 detected the watermark embedded in the speech audio signal of the inbound call audio signal.

The analytics database 304 and/or the provider database 312 may contain any number of corpora that are accessible to the analytics server 302 via one or more networks. The analytics server 302 may access a variety of corpora to retrieve clean audio signals, previously received audio signals, recordings of background noise, and acoustic impulse response audio data. The analytics database 304 and/or provider database 312 may contain any number of corpora that are accessible to the analytics server 302 via one or more networks. The analytics database 304 may also query an external database (not shown) to access a third-party corpus of clean audio signals containing speech or any other type of training signals (e.g., example noise). In some implementations, the analytics database 304 and/or the provider database 312 may be queried, referenced, or otherwise used by components (e.g., analytics server 302) of the system 300 to assist with configuring or otherwise establishing performance limits on watermarking in relation to audio and/or speech quality.

In some embodiments, the analytics database 304 and/or the provider database 312 may store information about speakers or registered callers as speaker profiles. A speaker profile is data files or database records containing, for example, audio recordings of prior audio samples, metadata and signaling data from prior calls, a trained model or speaker vector employed by the neural network, and other types of information about the speaker or caller. The analytics server 302 may query the profiles when executing the neural network and/or when executing one or more downstream operations. The profile could also store the registered feature vector for the registered caller, which the analytics server 302 references when determining a similarity score between the registered feature vector for the registered caller and the feature vector generated for the current caller who placed the inbound phone call.

The admin device 303 of the call analytics system 301 is a computing device allowing personnel of the call analytics system 301 to perform various administrative tasks or user-prompted analytics operations. The admin device 303 may be any computing device comprising a processor and software, and capable of performing the various tasks and processes described herein. Non-limiting examples of the admin device 303 may include a server, personal computer, laptop computer, tablet computer, or the like. In operation, the user employs the admin device 303 to configure the operations of the various components of the call analytics system 301 or service provider system 310 and to issue queries and instructions to such components.

The agent device 316 of the service provider system 310 may allow agents or other users of the service provider system 310 to configure operations of devices of the service provider system 310. For calls made to the service provider system 310, the agent device 316 receives and displays some or all of the relevant information associated with the call routed from the provider server 311.

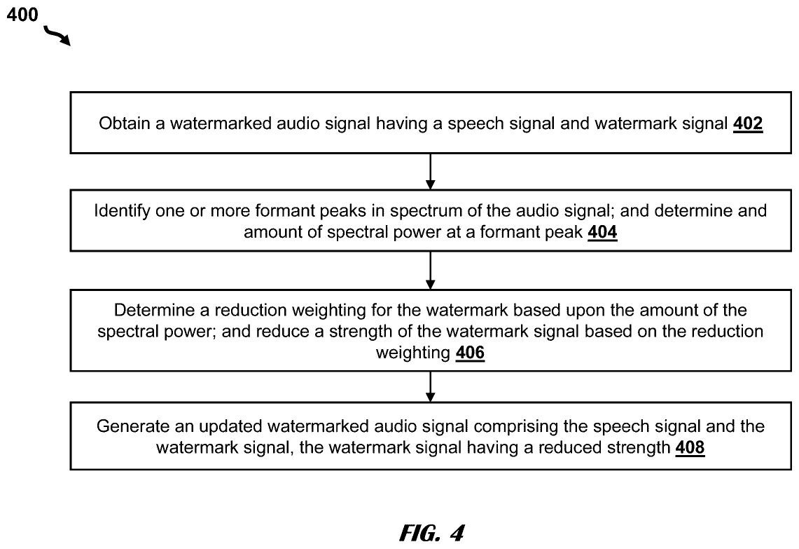

FIG. 4 shows operations of a process 400 for encoding audio signals by embedding and adjusting watermark signals according to an LPC-weighting operations. Embodiments may include additional or alternative operations, or omit certain operations, from the operations described for the example process 400, yet still fall within the scope of this disclosure. Moreover, for ease of description and understanding, the operations of the process 400 are described as being performed by a server (e.g., TTS server 322), but embodiments may be performed by various other types of computing devices (e.g., end-user device 314, analytics server 302).

In operation 402, the server obtains a watermarked audio signal having a speech signal and watermark signal including a watermark sequence. In some cases, the server obtains the watermarked audio signal by generating the watermarked audio signal corresponding to an inputted, watermark-free audio signal. The server may, for example, execute an encoder that implements operations for LPC-based spread spectrum watermarking that embeds a watermark signal into a watermark-free audio signal. In some embodiments, the server embeds the watermark signal into a speech signal at certain portions of the watermark-free audio signal. In some cases, the server obtains a previously watermarked audio signal, from another computing device or upstream operation or device that previously embedded the watermark to generate the watermarked audio signal. The server or the encoder of the server may receive the watermarked audio signal as transmitted from the upstream computing device or software program, or the server may retrieve the watermarked audio signal from a non-transitory machine-readable storage medium of the server or a database.

In operation 404, the server identifies one or more formant peaks in a spectrum of the watermarked audio signal. A formant peak of the speech signal of the watermarked audio signal contains a relatively higher amount of power satisfying a peak-detection threshold, indicative of the formant peak at a portion of the speech signal of the watermarked audio signal. The server may then determine an amount of spectral power of the audio signal at the formant peak. The watermarked audio signal, as obtained by the server, may be represented in any domain, such as time domain or spectral domain (or other type of transform domain). The encoder of the server may execute a transform function on the watermarked audio signal to generate a representation of the watermarked audio signal in a log-spectrum domain. The server then executes an LPC analysis of the log-spectrum domain of the watermarked audio signal to identify a formant peak in the spectrum of the watermarked audio signal, representing portions of the audio signal in which the watermark signal and the speech signal of the audio signal have the comparatively highest amount of energy. The server may, for example, detect formant peaks or formant troughs when the amount of power at a given set of one or more frames satisfies a formant peak threshold or formant trough threshold, which may be predetermined or dynamically determined by the server. The server executing the LPC analysis may determine the amount of spectral power of the audio signal occurring at the formant peak.

In operation 406, the server determines an LPC-based strength reduction weighting for the watermark along a frequency, w (k), based upon the amount of the spectral power. The intensity or strength of the watermark along frequency is often uniform, so the server may perform the LPC analysis to tailor the focus or shape of the watermark strength based on the formant peaks (or formant troughs), allowing the server to determine the watermark strength reduction weighting more efficiently. The server then reduces a strength o of the watermark ω signal at the formant peak based on the reduction weighting, thereby adjusting the strength of the watermark to generate a revised LPC spread-spectrum watermark sequence (ω_{lpc}) by obtaining an LPC log-spectrum (X_{lpc}(k)) for each frame of speech along frequency k. For instance, the encoder of the server may execute an LPC-based encoding function, which may include Equation 4 (below):

$${ω}_{lpc} ( k ) = δ ω ( k ) γ ( {X}_{lpc} ( k ) ) , \qquad ( Equation 4 )$$

where k is a frequency index in a frequency domain (or other index in another domain), δ is a strength of the watermark as a scaling factor or gain applied to the watermark signal, ω(k) is the original watermark sequence or pattern in the transform domain (e.g., log-spectrum domain, spectrum domain, frequency domain) at index k, and γ(k) is a relative LPC-weighting value applied to the watermark signal ω(k) at the index k; and where X_{lpc}(k) is the watermarked audio signal after LPC analysis at index k, such the LPC log-spectrum representation of the watermarked audio signal at each frame of speech. The function γ(X_{lpc}(k)) represents the LPC-weighting function that the server applies to the LPC-transformed watermarked audio signal, X_{lpc}(k) to reduce the strength of watermarked audio signal at the index.

Generally, the server executes Equation 4 to embed (or extract) the watermark ω(k) into or from the LPC-derived watermarked audio signal X_{lpc}(k). The use of LPC analysis allows the encoder's watermarking process to take advantage of the spectral properties of the inputted audio signal, making the watermark more robust to certain types of distortions.

During watermark embedding, the encoder scales the watermark ω (k) using the watermark strength & to generate the watermarked audio signal. The encoder may modify or adjust (e.g., reduce) the watermark strength according to the LPC characteristics of the watermarked audio signal, as represented by the watermark strength reduction value determined using the LPC-weight function γ(X_{lpc}(k)) of Equation 5 (below):

$$γ ( k ) = {( 1 - F ( k ) )}^{α} , \qquad ( Equation 5 )$$

where γ(k) represents a transformed or modified version of the watermark signal at index k; where F(k) is a distribution function of LPC domain, power, or other metrics based on the LPC log-spectrum analysis at the frequency index, and 1-F(k) represents a modification of F(k) by subtracting the value from 1, to invert or adjust the effect of the distribution function F(k); and where a is penalty parameter that controls the sensitivity or impact of the adjusted distribution function, 1-F(k), non-linearly controlling an amount or degree to which the corresponding frequencies are “penalized,” adjusts the nonlinearity of the transformation, making the effect stronger or weaker depending on its value, and thereby mitigating or dulling the effect of frequency for the watermark signal at the given frequency index.

Generally, the results of an LPC spectrum analysis contains a scaled version or representation of the spectral power with a focus on the formant peaks and/or troughs. When LPC analysis is applied to the watermark signal spectrum, the spectral shape generally follows the speech audio signal. The server can determine the LPC-weighting as an approximate inverse of the watermark signal strength at the peaks and troughs, as determined or identified from the results of the LPC analysis. The server can implement or adjust the penalty parameter (α) to increase or decrease the degree or severity of the LPC-weighting along the frequency. Where there is a formant peak in the watermark signal or the speech signal at different frequency indices (k), the LPC analysis identifies a relatively high LPC-spectral power, so the server returns a relatively lower LPC-weighting (e.g., γ(k) approaches ‘0’). Likewise, where there is a formant trough in the watermark signal or the speech signal at different frequency indices (k), the LPC analysis identifies a relatively low LPC-spectral power and returns a relatively higher LPC-weighting (e.g., γ(k) approaches ‘1’).

After determining the strength of the watermark signal and the LPC reduction weighting, the encoder of the server then adjusts the watermark signal by reducing the strength of the embedded watermark signal in the log-spectral domain at the formant peak according to the reduction weighting. For instance, the server executes the transform function according to the LPC reduction weighting, which results in updating the strength of the watermark signal of the speech signal having the formant peak according to the watermark strength reduction weighting.

In operation 408, the server generates and outputs an updated watermarked audio signal comprising the speech signal and the watermark signal as adjusted, where the watermark signal has the reduced strength. The encoder of the server may execute a transform function to return the updated watermarked audio signal from the log-spectral domain to the time domain, thereby generating the updated watermarked audio signal having the adjust watermark signal.

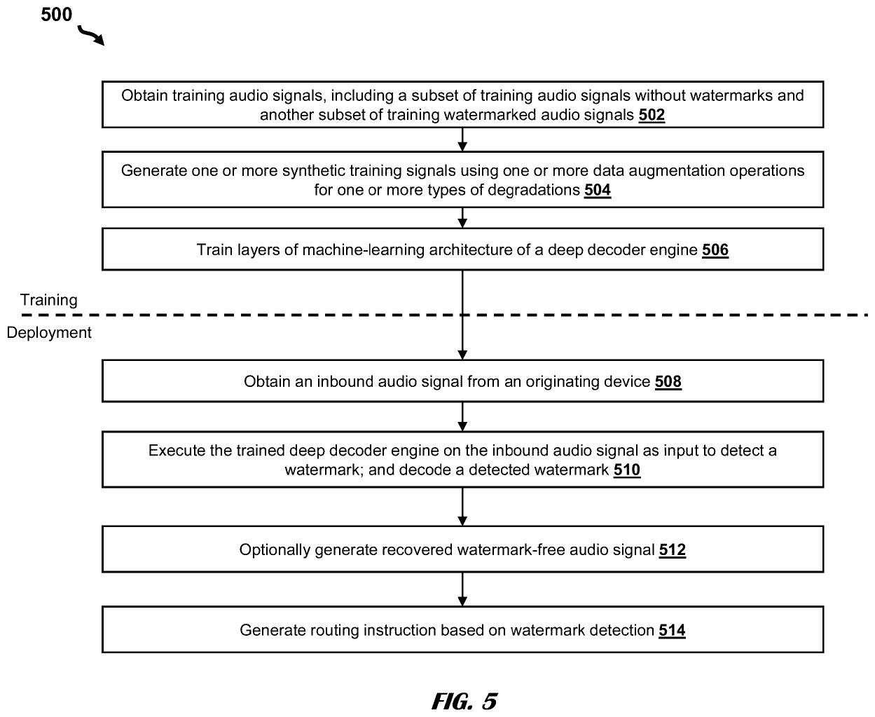

FIG. 5 shows operations of a process 500 for implementing deep decoding for decoding watermarked audio signals using a deep neural network architecture. Embodiments for watermark-decoding using machine-learning architecture(s) of a deep decoder may include additional or alternative operations, or omit certain operations, from the operations described for the example process 500, yet still fall within the scope of this disclosure. Moreover, for ease of description and understanding, the operations of the process 500 are described as being performed by decoder software programming of a server (e.g., analytics server 302), but embodiments may be performed by various other types of computing devices (e.g., end-user device 314, service provider system 310).

The decoder executed by the server includes software programming of a deep decoder engine (“deep decoder”), which includes various operations, layers, and other aspects (e.g., machine-learning models) of a machine-learning architecture. The server executes the deep decoder in a training phase for training or tuning the machine-learning model of the machine-learning architecture to detect a watermark and, in some cases, decode the embedded watermark. The server may further execute the deep decoder in a deployment phase (sometimes referred to as “testing” or “inference time”) to detect the watermark in an input audio signal and, in some implementations, decode the embedded watermark to extract information and/or generate a non-watermarked version of the inputted watermark audio signal. The machine-learning architecture of the deep decoder may also include layers for feature extraction or feature vector extraction (generally referred to as a “feature extractor” for ease of explanation). The feature extractor includes layers and functions of the machine-learning architecture for generating a transformed representation of an inputted call signal (e.g., training call signal, inbound call signal) indicating a value or metric in a transform domain (e.g., an amount of power in a spectral or frequency domain) at one or more frames of the inputted call signal. The layers and functions of the feature extractor include a machine-learning model trained to extract features (e.g., training features, inbound features) or feature vectors (e.g., training feature vector, inbound feature vector) corresponding to each frame of the one or more frames parsed from the inputted audio signal.

In a training phase, in operation 502, the server obtains training audio signals from a corpus database or other data source. The training audio signals may include a subset of training audio signals without watermarks and another subset of training watermarked audio signals. The training audio signals are stored in non-transitory machine-readable storage media, such as the server or other computing device hosting a database of call data or training data. The training audio signals may be stored with corresponding training labels, where each label includes metadata indicating information about the corresponding the training audio signal. For instance, the training label of a particular training audio signal may contain a binary value or other type of data value indicating whether the training audio signal contains a watermark signal.

In operation 504, the server generates one or more synthetic training signals using one or more data augmentation operations for one or more types of degradations. Non-limiting examples of the types of degradation include additive noise, reverberation, down-sampling, packet loss, codec compression, delay(s), and filtering, among others. A data augmentation operation takes a clean training audio signal as input and generates a corresponding synthetic training audio signal having a particular type of degradation. The server may generate a set of one or more synthetic training audio signals for a given training audio signal. Optionally, in some implementations a type of data augmentation operation may include embedding a watermark signal into an initial watermark-free training audio signal. The server may store the synthetic training signals into the database or other storage location containing the corpus of training audio signals.

In operation 506, the server trains the layers and machine-learning model of the deep decoder. The deep decoder includes operations for performing, for example, audio signal transform functions, watermark detection, and watermark decoding, among others. For each frame or for an aggregation of frames of the training audio signal, certain prediction functions or layers (e.g., dense layers, classifier layers, feature extraction layers) of the machine-learning architecture of the deep decoder to extract features and feature vectors for the frame or frames, and generate a watermark detection score indicting a probability that the frame or frames of the audio signal include a watermark signal.

The server feeds each training audio signal into the deep decoder to generate one or more predicted outputs, such as a watermark prediction or a predicted watermark detection score indicating a predicted likelihood that the training audio signal contains a watermark. The deep decoder may also generate and output representation of a predicted watermark-free audio signal (e.g., recovered audio signal 235, original audio signal 125) in a transform domain (e.g., log-spectrum domain, spectral domain, frequency domain). For a given training audio signal, the deep decoder may reference a corresponding training label associated with the training audio signal indicating one or more expected outputs for the training audio signal, such as an indicator of whether the training audio signal is watermark-free, and one or more expected representations of the training audio signal in one or more domains (e.g., log-spectrum domain, spectral domain, frequency domain), among other types of information. The deep decoder includes a loss function or similar operation that determines a level of error between the predicted outputs of the deep decoder and the expected outputs as indicated by the training labels, and then tunes the weights or parameters of the deep decoder according to one or more optimization parameters or functions, until the loss or level of error produced by the deep decoder satisfies a training threshold.

The deep decoder may include functions or operations of a decoder (e.g., decoder 230) for decoding the watermark and, optionally, returning a watermark-free audio signal (e.g., recovered audio signal 235). The deep decoder or other function the computer executing the decoder 230 may parse the input audio signal into one or more frames (or a plurality of frames) and generates, feeds the frames into the decoder, and the decoder predicts whether the frames contain a watermark signal or is watermark-free.

For instance, for spread spectrum watermarking, decoding may include applying a dot product operation to a decoded spectrum representing the watermark-free audio signal in a spectral domain, often in combination with a cepstral filter. For instance, the decoder multiplies the watermark sequence or watermark signal against the speech spectrum and generates the summation of the multiplication operations. If the decoder identifies a watermark score satisfies a detection threshold, then the decoder detects a watermark signal. This dot product approach of is generally an optimal solution for decoding in circumstances of minimal degradation.

In telephony-based circumstances, the degradation imposed on a watermarked audio signal may be significant. For example, the speech signal may pass from a loudspeaker (e.g., ambient additive noise, delay) and be captured by a microphone (e.g., filtering), and the telephony channel itself may cause further degradations (e.g., down-sampling, packet-loss, codec compression). The deep decoder approach replaces the summation operations with the layers of a neural network architecture. During training, the deep decoder of the server trains the machine-learning model to weight various spectral frequencies as comparatively more or less. The machine-learning model learns or is trained to determine which frequencies' powers levels should be given comparatively greater weight when estimating whether a watermark is present in the audio signal.

When the deep decoder detects the watermark signal in the frame, the deep decoder may then execute operations of a typical decoder for decoding the watermark signal. The deep decoder may, for example, perform the dot product operations for decoding the watermark signal. As another example, the deep decoder may obtain the decoded frames from the audio signals by executing the function, as in Equation 6 (below):

$$\hat{X} = g ( {}^{∼} {X}_{dB} ω ) , \qquad ( Equation 6 )$$

where ^{˜}X_{dB} is the power spectrum of a frame containing speech at indices where the watermark is encoded, and function ‘g( )’ is a cepstral filter operation. The decoder executes decode operations using Equation 6 in which a feature vector or transform representation of the watermarked signal ^{˜}X_{dB} is combined with the feature vector or transform representation of the watermark sequence w through the correlation or cepstral filtering function g ( ) to produce the output original or reconstructed audio signal X, such as a refined version of the original signal X that has undergone watermark detection or extraction. The function g(^{˜}X_{dB}ω) applies a cepstral filter (or other signal processing techniques to the input signal), which is designed and trained to extract relevant features from the watermarked audio signal that are indicative of the watermark's presence, where these relevant features are represented as a feature vector of values extracted from a spectral power (dB) domain or other domain representation of the watermarked audio signal.

For comparison, an output of a typical dot product operation for watermark decoding is obtained by executing the function Σ(X), which ordinarily sums together the feature vectors of the original audio signal or watermarked audio signal as multiplied with or compared against the feature vector of the expected watermark (e.g., as in Equation 3).

The decoder operations and techniques for decoding a watermark are merely examples and not intended to be limiting. The decoders and deep decoders described herein may include and execute any number of additional or alternative operations or techniques for watermark decoding to decode a watermark signal from a given watermarked audio signal input.

The output signal X of the function g ( ) represents the processed signal where the watermark information is more pronounced. The deep decoder then analyzes this output signal X to detect specific patterns in the spectral domain that indicate the presence of the watermark. The deep decoder compares or correlates the processed output signal X against feature vectors of known or expected watermark patterns. If the features of the feature vector of the output signal X have a watermark detection score (or similarity score) that satisfies a threshold distance or similarity from the of the expected watermark, then the decoder predicts that the frame contains a watermark. The prediction is typically based on correlation measures, error correction, and validation steps that confirm the watermark's presence despite any signal distortions. This process is repeated for each frame in a video, allowing the deep decoder to predict whether each frame contains the watermark. The decision is made by assessing the consistency and strength of the watermark signal across multiple frames.

For each the frames and/or for a statistical combination of multiple frames, deep decoder trains the weights and parameters to generate a watermark detection score indicating a predicted likelihood that that the particular frame or the audio signal contains a watermark. A decoder or deep decoder identifies or detects the watermark in the one or more frames in response to determining that the watermark detection score satisfies a watermark detection threshold. Optionally, the server generates a watermark detection output indicating whether the decoder or deep decoder detected the watermark in the frame or frames.

The loss layers of the deep decoder execute a loss function that generally compares a predicted watermark score and/or a predicted watermark detection output against an expected watermark score and/or an expected watermark detection output and generates or assigns a feedback training reinforcement score. The loss function may be configured or programmed to train or tune the parameters or weights of certain aspects of the deep decoder, according to optimization configuration parameters. As an example, the loss function tunes only the weights and parameters for ingesting audio signals or detecting a watermark, but the loss function does not tune the weights or parameters of the decoder function, such that the decoder function itself is fixed. As another example, the loss function may tune the weights and parameters of any component of the deep decoder, in accordance with an optimization instruction to optimize on certain performance outcomes (e.g., accuracy, speed).

The neural network architecture of the deep decoder is iteratively trained by the server using iterations of the next successive training call signal until the server determines that the deep decoder is trained. The training phase for the deep decoder may conclude when the loss function or other software routine executed by the server determines that the loss or level of error of the machine-learning architecture of the deep decoder satisfies the training threshold. The server places the trained deep decoder into a deployment phase for handling inbound audio signals, which may include inbound watermarked audio signals or inbound watermark-free audio signals.

During the deployment phase, in operation 508, the server obtains an inbound audio signal from an inbound audio source, such as an end-user device or TTS server, which includes an inbound call signal for an inbound call that originated via a telephony channel. The inbound audio signal may include an inbound watermark-free audio signal having a speech signal or an inbound watermarked audio signal having a speech signal and watermark signal embedded in the speech signal at portions of the inbound audio signal.

In operation 510, the server executes the trained deep decoder engine on the inbound audio signal to extract features or feature vectors from the inbound audio signal, and detect a watermark signal. When a watermark signal is detected, the server may decode the detected watermark. The deep decoder parses the inbound audio signal into frames and executes one or more transform functions on the frames to generate a transform representation of the frames in a transform domain (e.g., log-spectrum domain, spectral domain, frequency domain). The deep decoder then executes the feature extraction operations and the decoder operations. Generally, the decoder operations generate a watermark detection score for each frame based upon a cepstral filter function and the power spectrum of the feature vector(s) in the frame containing speech. When the decoder operations are applied to the power spectrum of a frame that contains speech at a frequency index where a watermark is encoded, then the decoder will compute a watermark detection score for the particular frame that satisfies a watermark detection threshold.

As an example, the decoder executes an operation such as a filtering operation, dot product operation, comparative operation, or other type of decoding operation. The decoder operations may use the inbound audio signal power along the frequency in the transform domain, an expected watermark or spreading sequence along the frequency in the transform domain, or a cepstral filter function, among other types of inputs. For each frame or aggregation of frames along frequencies, the decoder computes a watermark prediction score as generated by the comparative decoding operation. In typical dot product operations, these watermark prediction scores might be simply added together. The trained deep decoder generates and outputs the watermark prediction scores for each frame or aggregation of frames based upon the tuned weights assigned to the frequencies during training. When the trained deep decoder is computing the watermark detection scores for the frames or aggregated portions of the audio signal, the weights or parameters are tuned to give more weight or impact to certain spectral frequencies that are more likely indicative or determinative of the presence of a watermark. The deep decoder identifies or detects the watermark signal occurring in the frame or aggregation of frames in response to determining that the watermark detection score satisfies the detection threshold.

The server may perform any number of downstream operations in response to detecting or identifying the inbound audio signal containing watermark signals embedded in the speech signals of the inbound audio signal.

Optionally, in operation 512, the deep decoder or other components of the server generates a recovered watermark-free instance of the inbound audio signal, containing a watermark-free speech signal. In the transform domain (e.g., log-spectrum domain, spectral domain), the deep decoder identifies the frames containing instances of the watermark signal and estimates a difference between the watermark signal and the speech signal to then estimate the power or frequency of the watermark-free speech signal for the frame in the transform domain. The deep decoder then performs the transform function for each frame in accordance with the estimated watermark-free speech signal, thereby returning the inbound audio signal to the time domain as the recovered watermark-free audio signal.

In operation 514, the server generates a routing instruction indicating a call destination for the inbound call based upon the watermark detection score(s) (as determined in previous operation 510). In some embodiments, the routing instruction includes machine-readable instructions for a call routing device or service executing a call management software engine. The data of the routing instruction indicates a call destination device for the call routing device. Additionally or alternatively, in some embodiments, the routing instruction includes machine-readable data for generating or otherwise providing elements a graphical user interface indicating the watermark or whether the watermark has been detected by the server.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method for embedding watermarks in audio signals, comprising:
obtaining, by a computer, a watermarked audio signal comprising a speech signal and a watermark signal embedded at the speech signal;
determining, by the computer, a strength of the watermark signal at a formant peak of the speech signal in the watermarked audio signal;
determining, by the computer, a watermark strength reduction weighting based upon an amount of power of the speech signal at the formant peak;
updating, by the computer, the strength of the watermark signal of the speech signal having the formant peak according to the watermark strength reduction weighting; and
generating, by the computer, a revised watermarked audio signal comprising the watermark signal having the strength as updated using the watermark strength reduction weighting embedded at the speech signal.

2. The method according to claim 1, wherein the computer generates the revised watermarked audio signal by embedding the revised watermarked audio signal in a transform domain of the watermarked audio signal at the formant peak of the speech signal.

3. The method according to claim 1, wherein obtaining the watermarked audio signal includes parsing, by the computer, the watermarked audio signal into a plurality of frames, each frame having a preconfigured frame-length for speech, and wherein the watermark signal having a frame-length is embedded by the computer at the frame of the speech signal containing the formant peak.

4. The method according to claim 1, wherein obtaining the watermarked audio signal having the watermark signal includes:
executing, by the computer, a transform function to generate a transformed representation of a watermark-free audio signal in a transform domain; and
generating, by the computer, the watermarked audio signal comprising the watermark signal by embedding the watermark signal in the transform domain of the speech signal of the watermark-free audio signal.

5. The method according to claim 4, wherein obtaining the watermarked audio signal having the watermark signal includes generating, by the computer, a watermark sequence of the watermark signal comprising one or more watermark values in the transform domain.

6. The method according to claim 1, wherein obtaining the watermarked audio signal having the watermark signal includes receiving, by the computer, the watermarked audio signal via one or more networks.

7. The method according to claim 1, wherein determining the strength of the watermark signal at the formant peak includes identifying, by the computer, the formant peak in the watermarked audio signal, the formant peak of the speech signal of the watermarked audio signal containing a relatively higher amount of power satisfying a peak-detection threshold and indicative of the formant peak at a portion of the speech signal of the watermarked audio signal.

8. The method according to claim 7, wherein the computer executes a Linear Predictive Coding (LPC) analysis for identifying the formant peak in a transform domain of the watermarked audio signal of the speech signal.

9. The method according to claim 1, wherein the computer determines the watermark strength reduction weighting based upon a preconfigured penalty parameter and the amount of power of the speech signal at the formant peak.

10. The method according to claim 1, further comprising executing, by the computer, a transform function on the revised watermarked audio signal in a transform domain to generate an audible representation of the revised watermarked audio signal in a time domain.

11. A computer-implemented method for watermark-decoding using machine-learning, comprising:
receiving, by a computer, an inbound call signal for an inbound call that originated via a telephony channel;
generating, by the computer, a transformed representation of the inbound call signal indicating an amount of power at one or more frames in a transform domain at a portion of the inbound call signal;
for each frame, extracting, by the computer, a feature vector of a corresponding frame of the inbound call signal in the transform domain;
generating, by the computer using a neural network architecture of a deep decoder, one or more watermark detection scores for the one or more frames of the inbound call signal using the feature vector of the corresponding frame, wherein the neural network architecture is trained on a plurality of training call signals, including at least one training watermarked call signal and at least one training watermark-free call signal;
identifying, by the computer, a watermark signal being embedded in at least one frame of the inbound call signal in response determining that at least one watermark detection score satisfies a watermark detection threshold; and
generating, by the computer, a routing instruction indicating a call destination for the inbound call based upon the at least one watermark detection score.

12. The method according to claim 11, further comprising training, by the computer, the neural network architecture of the deep decoder for generating a watermark detection score based upon the amount of power at the portion of a transform domain of a call signal.

13. The method according to claim 12, wherein training the neural network architecture of the deep decoder includes:
extracting, by the computer using the neural network architecture, a training feature vector for a training call signal in the transform domain;
generating, by the computer using the neural network architecture, a predicted watermark detection score for the training call signal using the training feature vector; and
generating, by the computer using a loss function, a level of error indicating a loss between the predicted watermark detection score and an expected watermark label, indicated by a training label associated with the training call signal.

14. The method according to claim 12, wherein training the neural network architecture of the deep decoder includes:
for each training call signal, generating, by the computer using a data augmentation operation, a training synthetic signal having a type of degradation in the transform domain according to the data augmentation operation corresponding to the type of degradation, wherein the neural network architecture is iteratively trained by the computer using the plurality of training call signals that includes the training synthetic signal.

15. The method according to claim 14, wherein training the neural network architecture of the deep decoder includes:
extracting, by the computer using the neural network architecture, a training feature vector in the transform domain for the training synthetic signal;
generating, by the computer using the neural network architecture, a predicted watermark detection score for the training synthetic signal using the training feature vector; and
generating, by the computer using a loss function, a level of error indicating a loss between the predicted watermark detection score and an expected watermark label, indicated by a training label associated with the training call signal.

16. The method according to claim 14, wherein for each training call signal, the computer generates a plurality of training synthetic signals using a plurality of data augmentation operations corresponding to a plurality of types of degradation used for generating the plurality of training synthetic signals, and
wherein the type of degradation includes at least one of: additive noise, reverberation, down-sampling, packet loss, codec compression, delay, or filtering.

17. The method according to claim 11, wherein receiving the inbound call signal includes parsing, by the computer, the inbound call signal into the one or more frames, including the frame containing a speech signal.

18. The method according to claim 11, wherein the routing instruction indicating the call destination for the inbound call indicates a call destination device for a call routing device.

19. The method according to claim 11, wherein the routing instruction indicating the call destination for the inbound call includes a graphical user interface indicating whether the watermark signal has been detected by the computer.

20. The method according to claim 11, further comprising detecting, by the computer, synthetic speech in the inbound call signal, wherein the computer generates the one or more watermark detection scores for the inbound call signal in response to identifying the synthetic speech in the inbound call signal.
